(19) United States
(12) Patent Application Publication
(10) Pub. No.: US 2023/0119402 A1
(43) Pub. Date: Apr. 20, 2023

(54) MACHINE LEARNING TECHNIQUES FOR CROSS-DOMAIN TEXT CLASSIFICATION

(71) Applicant: Optum, Inc., Minnetonka, MN (US)

(72) Inventors: Amit Kumar, Gaya (IN); Suman Roy, Bangalore (IN); Ayan Sengupta, Noida (IN)

(21) Appl. No.: 18/069,771

(22) Filed: Dec. 21, 2022

(30) Foreign Application Priority Data
Sep. 20, 2020 (IN) 202211053756

(51) Int. Cl. G06N 5/022

(52) U.S. Cl. CPC G06N 5/022

(57) ABSTRACT

Various embodiments of the present invention provide methods, apparatus, systems, computing devices, computing entities, and/or the like for performing text classification predictions. Certain embodiments of the present invention utilize systems, methods, and computer program products that perform text classification predictions by using at least one of Word Mover's Similarity measures, Relaxed Word Mover's Similarity measures, or cross-domain classification machine learning model.

### CROSS-REFERENCES TO RELATED APPLICATIONS

The present application claims priority to Indian Provisional Patent Application No. 202211053756, filed Sep. 20, 2022, which is incorporated herein by reference in its entirety.

### BACKGROUND

Various embodiments of the present disclosure address technical challenges related to performing text classifications. Various embodiments, of the present disclosure disclose innovative techniques for performing cross-domain text classification.

### BRIEF SUMMARY

In general, various embodiments of the present disclosure provide methods, apparatus, systems, computing devices, computing entities, and/or the like for generating text classification predictions.

In accordance with one aspect, a method is provided. In one embodiment, the method comprises: for each of one or more input reference text data objects with respect to a set of candidate target text data objects, generating, using a computing entity and a cross-domain classification machine learning model, a set of maximal word similarity scores, wherein: (i) the cross-domain classification machine learning model has been pre-trained based at least in part on embeddings associated with source domain training data and target domain training data, (ii) the cross-domain classification machine learning model has been fine-tuned using labeled source domain training data based at least in part on a maximal word similarity-based contrastive loss function associated with the source domain training data and the target domain training data, and (iii) each maximal word similarity score in the set of maximal word similarity scores comprises a maximal value of a transition cost value associated with one or more reference words of the input reference text data object and one or more target words of a target text data object in the set of candidate target text data objects, wherein the transition cost value is determined based at least in part on: (a) a word-wise flow data object for the input reference text data object and the target text data object, wherein the word-wise flow data object comprises a word-wise flow value for each word pair comprising a reference word and a target word, and (b) a word-wise similarity value for each word pair; generating, using the computing entity, a classification output based at least in part on the set of maximal word similarity scores; and initiating, using the computing entity, the performance of one or more prediction-based actions based at least in part on the classification output.

In accordance with another aspect, a computer program product is provided. The computer program product may comprise at least one computer-readable storage medium having computer-readable program code portions stored therein, the computer-readable program code portions comprising executable portions configured to: for each of one or more input reference text data objects with respect to a set of candidate target text data objects, generate, using a cross-domain classification machine learning model, a set of maximal word similarity scores, wherein: (i) the cross-domain classification machine learning model has been pre-trained based at least in part on embeddings associated with source domain training data and target domain training data, (ii) the cross-domain classification machine learning model has been fine-tuned using labeled source domain training data based at least in part on a maximal word similarity-based contrastive loss function associated with the source domain training data and the target domain training data, and (iii) each maximal word similarity score in the set of maximal word similarity scores comprises a maximal value of a transition cost value associated with one or more reference words of the input reference text data object and one or more target words of a target text data object in the set of candidate target text data objects, wherein the transition cost value is determined based at least in part on: (a) a word-wise flow data object for the input reference text data object and the target text data object, wherein the word-wise flow data object comprises a word-wise flow value for each word pair comprising a reference word and a target word, and (b) a word-wise similarity value for each word pair; generate a classification output based at least in part on the set of maximal word similarity scores; and initiate the performance of one or more prediction-based actions based at least in part on the set of maximal word similarity scores.

In accordance with yet another aspect, an apparatus comprising at least one processor and at least one memory including computer program code is provided. In one embodiment, the at least one memory and the computer program code may be configured to, with the processor, cause the apparatus to: for each of one or more input reference text data objects with respect to a set of candidate target text data objects, generate, using a cross-domain classification machine learning model, a set of maximal word similarity scores, wherein: (i) the cross-domain classification machine learning model has been pre-trained based at least in part on embeddings associated with source domain training data and target domain training data, (ii) the cross-domain classification machine learning model has been fine-tuned using labeled source domain training data based at least in part on a maximal word similarity-based contrastive loss function associated with the source domain training data and the target domain training data, and (iii) each maximal word similarity score in the set of maximal word similarity scores comprises a maximal value of a transition cost value associated with one or more reference words of the input reference text data object and one or more target words of a target text data object in the set of candidate target text data objects, wherein the transition cost value is determined based at least in part on: (a) a word-wise flow data object for the input reference text data object and the target text data object, wherein the word-wise flow data object comprises a word-wise flow value for each word pair comprising a reference word and a target word, and (b) a word-wise similarity value for each word pair; generate a classification output based at least in part on the set of maximal word similarity scores; and initiate the performance of one or more prediction-based actions based at least in part on the set of maximal word similarity scores.

### BRIEF DESCRIPTION OF THE SEVERAL VIEWS OF THE DRAWINGS

Having thus described the disclosure in general terms, reference will now be made to the accompanying drawings, which are not necessarily drawn to scale, and wherein:

FIG. 1 provides an exemplary overview of an architecture that can be used to practice embodiments of the present disclosure.

FIG. 2 provides an example predictive data analysis computing entity in accordance with some embodiments discussed herein.

FIG. 3 provides an example client computing entity in accordance with some embodiments discussed herein.

FIG. 4 is a flowchart diagram of an example process for generating a cross-domain classification machine learning model in accordance with some embodiments discussed herein.

FIG. 5 provides an operational example of generating a Word Mover's Similarity (WMS) measure in accordance with some embodiments discussed herein.

FIG. 6 is a flowchart diagram of an example process for fine-tuning a machine learning model in accordance with some embodiments discussed herein.

FIG. 7 is a flowchart diagram of an example process for determining text classification for an input reference text data object using a cross-domain classification machine learning model in accordance with some embodiments discussed herein.

FIG. 8 provides an operational example for determining embeddings for text data objects in accordance with some embodiments discussed herein.

FIG. 9 provides an operational example of a classification output user interface in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. Overview and Technical Improvements

Various embodiments of the present invention introduce techniques for text classification that improves prediction accuracy of performing text classifications and reduces computational complexity of performing text classifications. One particular problem that is addressed by various embodiments of the present invention concerns assigning one or more target text data objects to an input reference text data object (e.g., assigning medical diagnosis code descriptions to clinical text) in order to determine target text data objects that relate to the input reference text data object. This computational problem is complicated by the sparseness of labeled documents (e.g., labeled reference text data objects) to effectively and efficiently train machine learning models to perform predictive tasks, a feature that undermines the ability of various existing natural language processing frameworks in accurately performing text classifications given a list of target text data objects that are configured to be assigned to reference text data objects.

Various embodiments of the present invention address the above-noted challenges by utilizing cross domain knowledge by training a machine learning model with data originating from a first data source (e.g., source domain) to generate embeddings that enable the machine learning model to be used to generate text classification predictions for data originating from a second data source (target domain) that is different from the first data source. By utilizing the noted-cross domain techniques, various embodiments of the present invention can utilize a cross-domain classification machine learning model that is trained on labeled data from a first data source to generate text classifications for unlabeled data from a second data source, thereby leveraging available data, which in turn improves the prediction accuracy of predictive data analysis systems (e.g., based at least in part on the increased labeled data).

Various embodiments of the present invention address the above-noted challenges by pre-training the weights of a machine learning model that is subsequently fine-tuned using supervised task-specific training data (e.g., labeled data from source domain and labeled data from target domain (if available) based at least in part on a Word Mover's Similarity measure (e.g., based at least in part on a contrastive loss function that is a contrastive loss in the form of differential WMS). By doing so, various embodiments of the present invention: (i) minimize (or prevent) overfitting, (ii) improve machine learning model training, and (iii) improve convergence speed.

Furthermore various embodiments of the present invention introduce techniques for performing text classification predictions by utilizing fast listwise text comparisons based at least in part on a Word Mover's Similarity measure which measures the predicted similarity score for a reference text data object and a target text data object using a maximal word similarity score for the reference text data object and the target text data object, wherein: (i) the maximal word similarity score describes a maximal value of a transition cost value associated with one or more reference words of the reference text data object and one or more target words of the target text data object, and (ii) the transition cost value is determined based at least in part on: (a) a word-wise flow data object for the reference text data object and the target text data object that describes, for each word pair comprising a reference word and a target word, a word-wise flow value, and (b) a word-wise similarity value for each word pair. In some embodiments, maximizing the transition cost value is performed in accordance with a first maximization constraint requiring that a sum of each word-wise flow value for a particular reference word of the one or more reference words is equal to a document-wide word weight value for the particular reference word in the reference text data object, and a second maximization constraint requiring that a sum of each word-wise flow value for a particular target word of the one or more target words is equal to a document-wide word weight value for the particular target word in the target text data object. By framing the list-wise text similarity determination problem as a maximization problem, the Word Mover's Similarity measure can provide a text similarity measure that is more efficient than the state-of-the-art systems, thus increasing efficiency of performing list-wise text similarity determination relative to existing natural language processing solutions and providing efficient and reliable solutions for performing list-wise text similarity determination.

Various embodiments of the present invention address the above-noted challenges by utilizing a Relaxed Word Mover's Similarity measure which measures the predicted similarity score for a reference text data object and a target text data object using a maximal word similarity score for the reference text data object and the target text data object, wherein: (i) the maximal word similarity score describes a maximal value of a transition cost value associated with one or more reference words of the reference text data object and one or more target words of the target text data object, and (ii) the transition cost value is determined based at least in part on: (a) a word-wise flow data object for the reference text data object and the target text data object that describes, for each word pair comprising a reference word and a target word, a word-wise flow value, and (b) a word-wise similarity value for each word pair. In some embodiments, maximizing the transition cost value is performed in accordance with a maximization constraint requiring that a sum of each word-wise flow value for a particular target word of the one or more target words is equal to a document-wide word weight value for the particular target word in the reference text data object. In some embodiments, the document-wide word weight value is determined based at least in part on: (i) a term frequency inverse document frequency value of the particular target word in the target text data object, and (ii) a sum of each term frequency-inverse document frequency value for the one or more target words in the target text data object. By framing the list-wise text similarity determination problem as a maximization problem, the Relaxed Word Mover's Similarity measure can provide a text similarity measure that is more efficient than the state of the art systems as well as the Word Mover's Similarity measure in terms of time and storage requirements, thus increasing efficiency of performing list-wise text similarity determination relative to existing natural language processing solutions and providing efficient and reliable solutions for performing the problem of list-wise text similarity determination.

Various embodiments of the present invention address the above-noted challenges by utilizing a cross-domain classification machine learning model that is trained to generate text classifications for input reference text data objects (e.g., target domain reference text data objects) based at least in part on maximal word similarity-based contrastive loss function associated with source domain training data and target domain training data, where the maximal word similarity-based contrastive loss function is configured to maximize a similarity measure for positive text data object pairs (comprising a training reference text data object and corresponding assigned target text data object for the training reference text data object) while minimizing the similarity measure for negative text data object pairs (comprising a training reference text data object and corresponding unassigned target text data object).

An exemplary application of various embodiments of the present invention relates to performing International Classification of Diseases (ICD) code assignment. Accordingly, various embodiments of the present invention relate to assigning ICD codes/ICD code descriptions to clinical texts. For classifying diseases, a hierarchy of diagnostic coding is provided by the ICD, and these diagnostic codes are known as ICD codes. Medical coding is a mandatory process for medical care and patient billing. Through this process, a coder assigns a set of ICD codes to a patient visit, a discharge summary, and the like. Manual coding can be tedious, subjective, time consuming, error-prone, and expensive.

Various embodiments of the present invention relate to assigning ICD codes to clinical texts by finding the similarity value between the clinical text and an ICD code. Other aspects rank the ICD codes against the clinical text by comparing the similarity values between the text and the codes in a listwise fashion, and compute similarity between two texts using the concept of Word Mover's Distance (WMD), a technique that to the best of the inventors' knowledge is innovative and has not been done before. WMD may be used to formulate a distance function between text documents. Various embodiments of the present invention reverse the formulation of WMD distance measure by finding the maximum amount of similarity that the embedded words of one document need to travel to the embedded words of another document and use this maximum amount of similarity to compute the similarity between the two noted documents.

Various embodiments of the present invention assume each word in the two texts is represented as a fixed dimensional embedded vector. Various embodiments of the present invention move the words of ICD text of an ICD code to the words of the clinical text in such a way such that the mass of a word (e.g., as determined based at least in part on the term-frequency-inverse-document-frequency (TF-IDF of the word) gets distributed over the words in the clinical text in a manner that maximizes the similarity between the clinical text and the ICD text in question. This can be posed as an optimization problem, referred to herein as the Word Mover's Similarity problem.

### II. Definitions

The term “text data object” may refer to a data entity that is configured to describe a collection of text data. Examples of text data objects include reference text data objects and target text data objects. In some embodiments, a set of candidate target text data objects are processed to determine a predicted text classification for a reference text data object (e.g., input reference text data object) based at least in part on one or more most similar target text data objects to the reference text data object having a threshold-satisfying similarity score (e.g., threshold-satisfying maximal word similarity score). Examples of reference text data objects include clinical texts, such as discharge diagnosis. Examples of target text data objects include diagnosis code descriptions, such as hierarchical condition category (HCC) descriptions and International Classification of Diseases (ICD) code descriptions, such as ICD-10 code descriptions. For example, in some embodiments, one or more diagnosis codes (e.g., ICD codes) is assigned to a medical note document (e.g., clinical note) based at least in part on the most similar diagnosis code descriptions (e.g., ICD code descriptions) for the medical note document having a threshold-satisfying maximal word similarity score. In some embodiments, a set of candidate target text data objects are processed to determine a set of n most similar target text data objects to a reference text data object in a descending order of similarity. For example, in some embodiments, the top n most similar diagnosis code descriptions for a medical note document (e.g., a discharge summary document) are ranked in a descending order of similarity of the n diagnosis code descriptions to the medical note document. A target text data object, for example, may describe a text data object that may be assigned to a reference text data object based at least in part on a similarity measure (e.g., maximal word similarity score) associated with the pair of target text data object and reference text data object.

The term “input reference text data object” may refer to a data entity that is configured to describe a text data object originating from (or otherwise is associated with) a target domain data source, and with respect to which a classification output (e.g., text classification predictions) may be generated using a cross-domain classification machine learning model. In some embodiments, input reference text data objects may be processed with respect to a set of candidate target text data objects to generate classification outputs for the input reference text data objects. Examples of input reference text data objects may include clinical texts, such as discharge diagnosis, medical notes, and/or the like.

The term “candidate target text data objects” may refer to a data entity that is configured to describe one or more target text data objects associated with a target domain (e.g., a target domain data source) and a source domain (e.g., a source domain data source), and that may be assigned to an input reference text data object. For example, in some embodiments, a set of candidate target text data objects may describe a classification space associated with a machine learning model (such as a cross-domain classification machine learning model), wherein the machine learning model may process input reference text data objects with respect to the classification space (e.g., set of candidate target text data objects) to generate classification outputs (e.g., one or more target text data objects) for the input reference text data objects. Examples of candidate text data objects may include a set of one or more diagnosis code descriptions, such as a set of hierarchical condition category (HCC) descriptions, a set of International Classification of Diseases (ICD) code descriptions, and or the like.

The term “threshold-satisfying maximal word similarity score” may refer to a data entity that is configured to describe a score that satisfies (e.g., exceeds) a threshold similarity score, such as a maximal word similarity score. In some embodiments, a target text data object may be assigned to a reference text data object based at least in part on determining whether a maximal word similarity score with respect to the target text data object and the reference text data object satisfy a threshold similarity score, wherein in response to determining that the maximal word similarity score satisfies the threshold similarity score, the target text data object may be assigned to the reference text data object.

The term “target domain data source” may refer to a data entity that is configured to describe a data source (e.g., repository, and/or the like) with respect to which classification predictions may be generated for text data objects (e.g., unlabeled text data objects) originating from the data source or otherwise associated with the data source. An example of a target domain data source may include a repository (e.g., database) associated with a medical insurance provider, wherein the repository may include data that describes unlabeled clinical text, such as discharge diagnosis. In some embodiments, a target domain data source may include training data (e.g., target domain training data) that may be used to pre-train a machine learning model, wherein the pre-trained machine learning model may further be fine-tuned, using text data objects originating from a source domain data source, to generate a cross-domain classification machine learning model. In some embodiments the target domain data source may comprise training data (e.g., target domain training data), as well as input reference text data objects with respect to which classification outputs (e.g., text classification predictions) may be generated using the cross-domain classification machine learning model.

The term “source domain data source” may refer to a data entity that is configured to describe a data source (e.g., repository, and/or the like) that is different from the target domain data source, and that may comprise data that may be utilized to train a machine learning model, such as a cross-domain classification machine learning model, to generate text classification predictions for text data objects originating from a target domain data source. A source domain data source, for example, may comprise training data (e.g., source domain training data) that may be used to pre-train the cross-domain classification machine learning model, and may be used to fine-tune (e.g., train) the cross-domain classification machine learning model. For example, in some embodiments, the cross-domain classification machine learning model may be pre-trained using labeled source domain training data and/or unlabeled source domain training data (e.g., originating from the source domain data source), as well as unlabeled target domain training data (e.g., originating from a target domain data source). In the noted example, the cross-domain classification machine learning model may be subsequently fine-tuned using labeled source domain training data.

The term “training data” may refer to a data entity that is configured to describe a collection of reference text data objects that are used to train a machine learning model to perform one or more tasks, such as a classification prediction task. In some embodiments, examples of training data may include source domain training data and target domain training data, wherein the source domain training data and target domain training data may be used to pre-train a machine learning model to learn preliminary embeddings of data associated with the source domain and data associated with the target domain. Examples of training data include labeled training data and unlabeled training data. For example, in some embodiments, a machine learning model may be pretrained using labeled source domain training data and/or unlabeled training data, as well as target domain labeled training data and/or unlabeled training data.

The term “labeled training data” may refer to a data entity that is configured to describe a collection of text data that have been assigned a semantic label (e.g., a collection of reference text data objects that have been assigned one or more target text data objects), and that are used to train a machine learning model to perform one or more tasks, such as classification prediction tasks. In some embodiments, examples of labeled training data include labeled source domain training data and labeled target domain training data.

The term “unlabeled training data” may refer to a data entity that is configured to describe a collection of text data that have not been assigned a semantic label (e.g., a collection of reference text data objects that have not been assigned a target text data object), and that are used to train a machine learning model to perform one or more tasks, such as classification prediction tasks. In some embodiments, examples of unlabeled training data include unlabeled source domain training data and unlabeled target domain training data.

The term “maximal word similarity score” may refer to a data entity that is configured to describe a measure of similarity of two text data objects (e.g., a reference text data object and a target text data object) that describes a maximum cost required to transform the words of a first text data object (e.g., target words of a target text data object) into words of a second text data object (e.g., reference words of a reference text data object). For example, the maximal word similarity score may describe a maximum cost required to transform the target words of a target text data object into reference words of a reference text data object using word-wise similarity values between embeddings of the reference words and the embeddings of the target words. In some embodiments, the maximal word similarity score for a reference text data object and a target text data object may describe a maximal value of a transition cost value associated with one or more reference words of the reference text data object and one or more target words of the target text data object.

The term “transition cost value” may refer to a data entity that is configured to describe a measure of cost required to transform the words of a first text data object (e.g., target words of a target text data object) into words of a second text data object (e.g., reference words of a reference text data object). For example, the transition cost value may describe a cost required to transform the target words of a target text data object into reference words of a reference text data object using word-wise similarity values between embeddings of the reference words and the embeddings of the target words. In some embodiments, the transition cost value for a reference text data object and a target text data object may be determined based at least in part on: (i) a word-wise flow data object for the reference text data object and the target text data object that describes, for each word pair comprising a reference word and a target word, a word-wise flow value, and (ii) a word-wise similarity value for each word pair.

The term “document-wide word weight value” may refer to a data entity that is configured to describe the frequency of a given word in a text data object with respect to the one or more words in the text data object. In some embodiments, a document-wide word weight value for a given target word in a target text data object may be determined based at least in part on: (i) TF-IDF value of the given target word in the target text data object, and (ii) a sum of each TF-IDF value for the one or more target words in the target text data object. In some embodiments, a document-wide word weight value for a given reference word in a reference text data object may be determined based at least in part on: (i) TF-IDF value of the given reference word in the reference text data object, and (ii) a sum of each TF-IDF value for the one or more reference words in the reference text data object.

The term “word-wise flow value” may refer to a data entity that is configured to describe a component of the document-wide word weight value for a word of a first text data object that is transitioned to a second word of a second text data object. For example, a word-wise flow value may describe a component of the document-wide word weight value for a reference word of a reference text data object that is transitioned to a target word of a target text data object. As another example, a word-wise flow value may describe a component of the document-wide word weight value for a target word of a target text data object that is transitioned to a reference word of a reference text data object. In some embodiments, the combination of all of the various word-wise flow values for reference words of a reference text data object and target words of a target text data object are described by a word-wise flow matrix for the reference text data object and the target text data object. In some embodiments, the sum of all word-wise flow values for a particular reference word may be equal to a text-wide word weight value for the particular reference word in the reference text data object. In some embodiments, the sum of all word-wise flow values for a particular target word may be equal to a text-wide word weight value for the target word in the target text data object.

The term “text-wide word weight value” may refer to a data entity that is configured to describe a frequency of a corresponding word in a particular text data object relative to the frequencies of other words in the particular text data object. For example, the text-wide weight value may describe a term frequency of a corresponding word in a particular text data object relative to the term frequencies of other words in the particular text data object. As another example, the text-wide weight value may describe a term-frequency-inverse-document-frequency measure of a corresponding word in a particular text data object relative to the term-frequency-inverse-document-frequency measures of other words in the particular text data object. In some embodiments, maximizing a transition cost value is performed in accordance with a maximization constraint requiring that a sum of each word-wise flow value for a particular reference word of the one or more reference words in a reference text data object is equal to a text-wide word weight value for the particular reference word in the reference text data object. In some embodiments, maximizing a transition cost value is performed in accordance with a maximization constraint requiring that a sum of each word-wise flow value for a particular target word of the one or more target words in a target text data object is equal to a text-wide word weight value for the particular target word in the target text data object.

The term “threshold-satisfying word pair” may refer to a data entity that is configured to describe a pair of text data objects (e.g., a reference text data object and a target text data object) that is deemed to have a threshold-satisfying similarity. For example, in some embodiments, a threshold-satisfying word pair may describe, for a target word from a target text data object and with respect to a reference text data object, a word pair including the target word and a reference word from the reference text data object that is deemed to have a threshold-satisfying similarity with respect to the target word. In some embodiments, the threshold-satisfying word pair for a given target word may include r target word pairs, where the r target word pairs may comprise the r word pairs having the top word-wise similarity values relative to one or more word-wise similarity values, where each of the one or more similarity values correspond a word pair comprising the target word and a particular reference word from the reference text data object. For example, given a target word wᵢ^{g} and a reference text data object d={wⱼ¹, wⱼ², wⱼ³, wⱼ⁴}, if s(wᵢ^{g}, wⱼ¹)=0.45 (the word-wise similarity value for wᵢ^{g} and wⱼ¹ equals 0.45), s(wᵢ^{g}, wⱼ²)=0.55 (the word-wise similarity value for wᵢ^{g} and wⱼ² equals 0.55), s(wᵢ^{g}, wⱼ³)=0.70 (the word-wise similarity value for wᵢ^{g} and wⱼ³ equals 0.70), s(wᵢ^{g}, wⱼ⁴)=0.50 (the word-wise similarity value for wᵢ^{g} and wⱼ³ equals 0.50), and if r=1, then the threshold-satisfying word pair for wᵢ^{g} with respect to the reference text d includes word pair (wᵢ^{g}, wⱼ³). In some embodiments, a maximal word similarity score for a pair of target text data object and reference text data object may be generated based at least in part on word-wise similarity values for word pairs associated with the pair of target text data object and reference text data object that are deemed threshold-satisfying word pairs.

The term “word-wise similarity value” may refer to a data entity that is configured to describe a value that describes a computed measure of similarity between two corresponding words. In some embodiments, the word-wise similarity value for a pair of words may be determined based at least in part on a measure of similarity (e.g., a measure of cosine similarity) of the embeddings (e.g., Word2Vec representations) of the noted words. In some embodiments, a word-wise similarity value for a given target word (e.g., from a target text data object) with respect to a given reference text data object may comprise a threshold-satisfying word pair.

The term “preliminary embedding” may refer to a data construct that describes an initial representation of features from input data objects, such as reference text data objects and target text data objects. In some embodiments, preliminary embedding for source domain text data objects and target domain text data objects may be determined based at least in part on pre-training a machine learning model using, for example, masked language modeling.

The term “cross-domain classification machine learning model” may refer to a data construct that describes parameters, hyperparameters, and/or defined operations of a machine learning model, wherein the machine learning model is configured to generate text classification predictions for input reference text data objects (e.g., target domain reference text data objects), and wherein the machine learning model is trained on labeled source domain reference text data objects. In some embodiments, the cross-domain classification machine learning model comprise a word-level encoding layer configured for generating a word embedding of each reference word of a reference text data object, and (ii) a document-level encoding layer configured for generating a document embedding of the reference text data object based at least in part on the word embedding for each reference word. For example, in some embodiments, the machine learning model comprises a hierarchical transformer machine learning model, such as a Bidirectional Encoder Representation from Transformers (BERT)-based machine learning model comprising a BERT layer that is layered on top with a Long Short-Term Memory (LSTM) layer. In some embodiments of the present disclosure, the cross-domain classification machine learning model may include an input embedding module, wherein the input embedding module may include a description encoder that generates a latent representation vector for a description corresponding to a feature. In some embodiments, each feature may be associated with a description that describes the semantics of the features. For example, a feature such as a diagnostic code may be associated with a short text description that describes the semantics of the diagnostic code.

The term “classification output” may refer to a data construct that describes a classification (e.g., text classification) generated by a machine learning model (e.g., a cross-domain classification machine learning model) with respect to an input reference text data object and a set of candidate target text data objects. The classification output may comprise one or more predicted classification labels (e.g., one or more predicted target text data objects). As an example, in some embodiments, the classification labels (e.g., target text data objects) may comprise medical codes, e.g., ICD codes descriptions, ICD codes corresponding to ICD code descriptions, CPT codes, and RX codes that are generated as classification output for prediction.

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

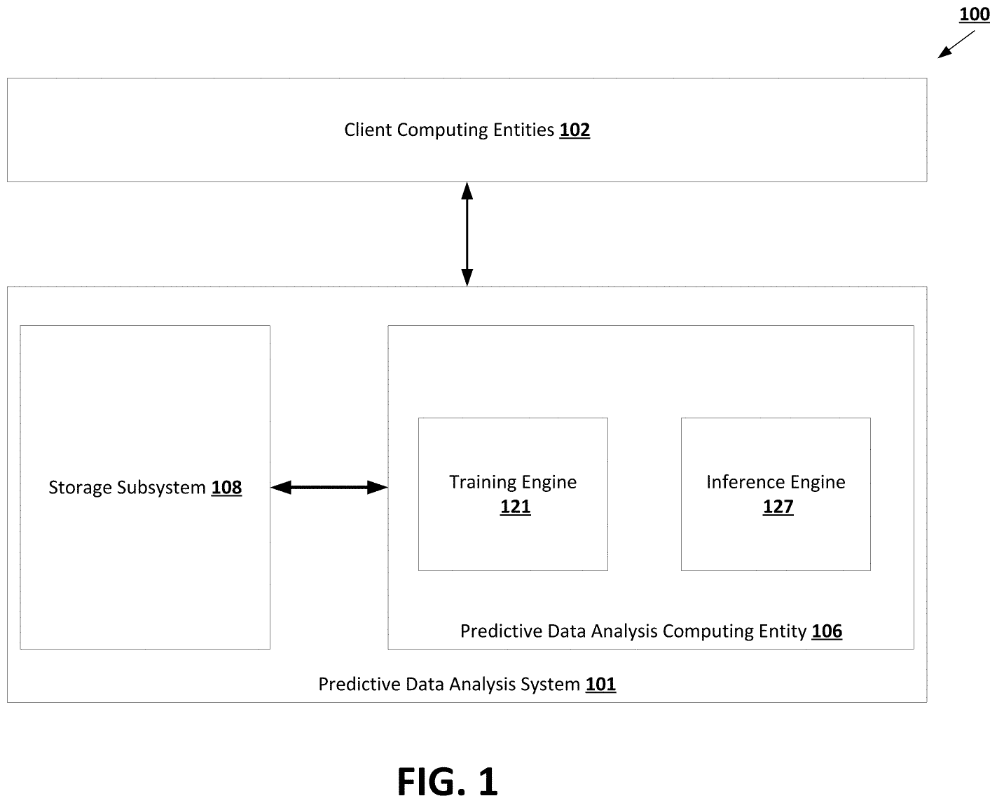

FIG. 1 is a schematic diagram of an example architecture 100 for performing predictive data analysis. The architecture 100 includes a predictive data analysis system 101 configured to receive predictive data analysis requests (e.g., text classification requests) from client computing entities 102, process the predictive data analysis requests to generate predictions, provide the generated predictions to the client computing entities 102, and automatically perform prediction-based actions based at least in part on the generated predictions.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more client computing entities 102, process the predictive data analysis requests to generate predictions corresponding to the predictive data analysis requests, provide the generated predictions to the client computing entities 102, and automatically perform prediction-based actions based at least in part on the generated predictions.

The predictive data analysis computing entity 106 may include a training engine 121 configured to generate trained machine learning models, such as a cross-domain classification machine learning model. The predictive data analysis computing entity 106 may further include an inference engine 127 configured to generate classification output (e.g., text classifications) using the trained cross-domain classification machine learning model. The inference engine 127 of the predictive data analysis computing entity 106 may be further configured to perform prediction-based actions based at least in part on the generated classification output.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

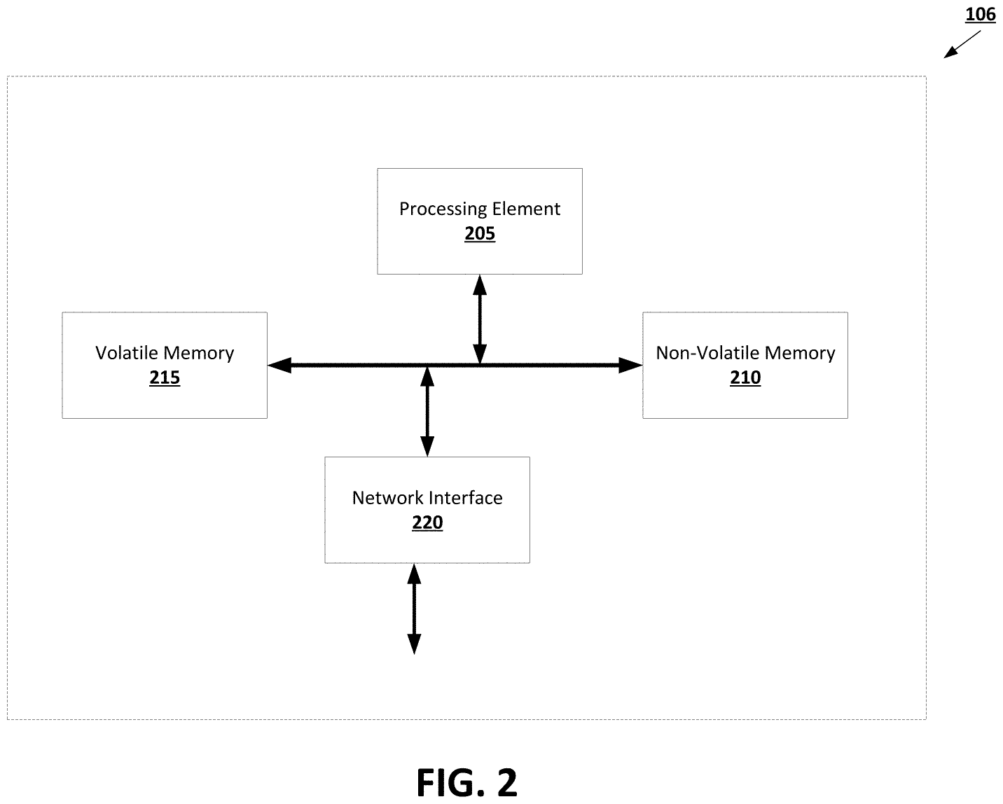

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 702.11 (Wi-Fi), Wi-Fi Direct, 702.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### Exemplary Client Computing Entity

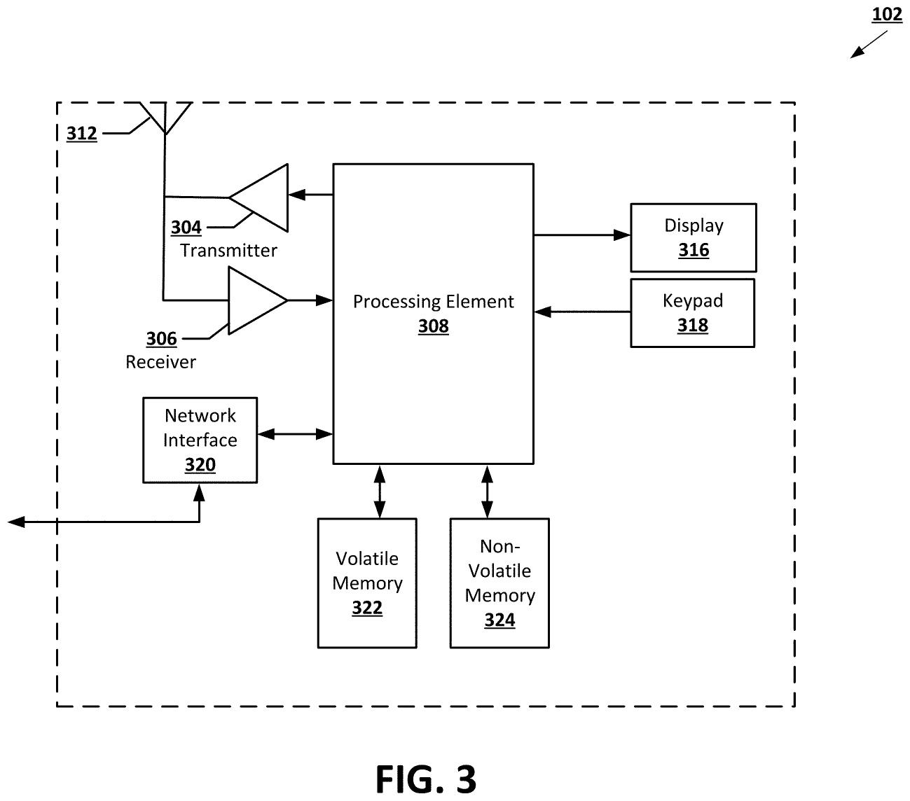

FIG. 3 provides an illustrative schematic representative of a client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the predictive data analysis computing entity 106 and/or various other computing entities.

In another embodiment, the client computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

As described above, various embodiments of the present invention introduce techniques for text classification that improves prediction accuracy of performing text classifications and reduces computational complexity of performing text classifications. One particular problem that is addressed by various embodiments of the present invention concerns assigning one or more target text data objects to an input reference text data object (e.g., assigning medical diagnosis code descriptions and/or a medical diagnosis code to clinical text) in order to determine target text data objects that relate to the input reference text data object. This computational problem is complicated by the sparseness of labeled documents (e.g., labeled reference text data objects) to effectively and efficiently train machine learning models to perform predictive tasks, a feature that undermines the ability of various existing natural language processing frameworks in accurately performing text classifications given a list of target text data objects that are configured to be assigned to reference text data objects.

Various embodiments of the present invention address the above-noted challenges utilizing cross domain knowledge by training a machine learning model with data originating from a first data source (source domain) to generate embeddings that enable the machine learning model to be used to generate text classification predictions for data originating from a second data source (target domain) that is different from the first data source. By utilizing the noted-cross domain techniques, various embodiments of the present invention can utilize a cross-domain classification machine learning model that is trained on labeled data from a first data source to generate text classifications for unlabeled data from a second data source, thereby leveraging available data, which in turn improves the prediction accuracy of predictive data analysis systems (e.g., based at least in part on the increased labeled data).

Further, various embodiments of the present invention address the above-noted challenges by pre-training the weights of a machine learning model, such as a cross-domain classification machine learning model, that is subsequently fine-tuned using supervised task-specific training data (e.g., labeled data from source domain and labeled data from target domain (if available) based at least in part on a Word Mover's Similarity measure (e.g., based at least in part on a contrastive loss function that is a contrastive loss in the form of differential WMS). By doing so, various embodiments of the present invention: (i) minimize (or prevent) overfitting, (ii) improve machine learning model training, and (iii) improve convergence speed.

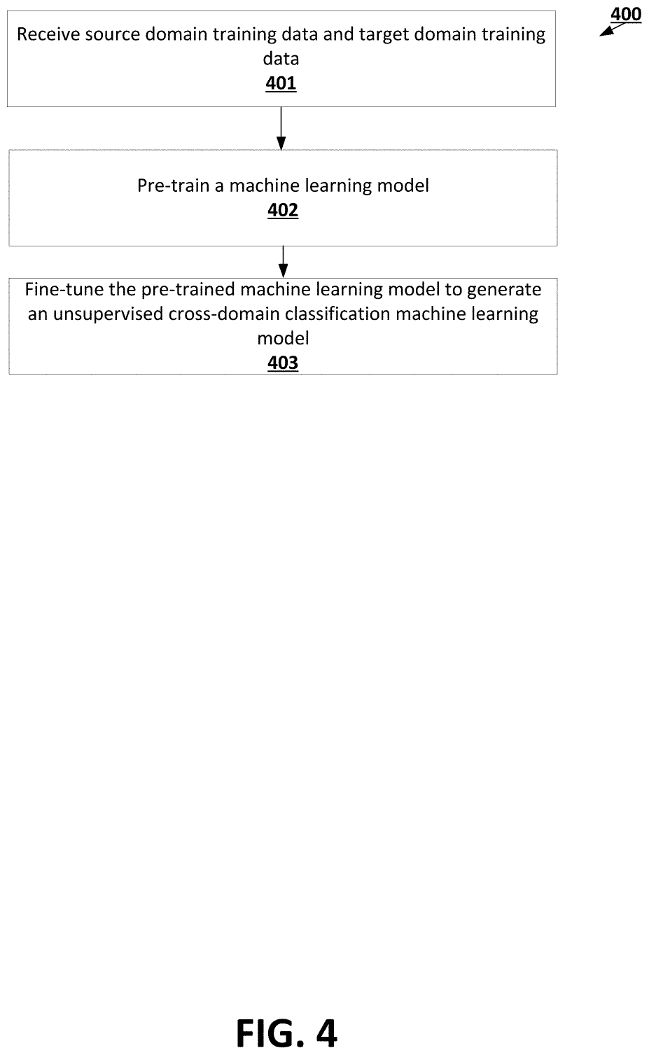

FIG. 4 is a flowchart diagram of an example process 400 for generating a cross-domain classification machine learning model, wherein the cross-domain classification machine learning model may be configured to generate text classifications for reference text data objects. Via the various steps of process 400, the training engine 121 of the predictive data analysis computing entity 106 can efficiently train a cross-domain classification machine learning model, using data from a first data source (e.g., labeled source domain training data) to generate text classifications for unlabeled data (e.g., reference text data objects) originating from a second data source (e.g., target domain data).

### Generating the Cross-Domain Classification Machine Learning Model

The process 400 begins at step operation 401 when the training engine 121 of the predictive data analysis computing entity 106 receives source domain training data and target domain training data. In some embodiments, source domain training data refers to data that is received from a first data source, and that can be used to train a machine learning model, while target domain training data refers to training data that is received from a second data source that is different from the first data source, and that can also be used to train the machine learning model. In some embodiments, a cross-domain classification machine learning model may be configured to generate text classifications for input reference text data objects comprising target domain data (e.g., originating from a target domain data source), while using source domain training data to train the cross-domain classification machine learning model.

In some embodiments, the source domain training data and target domain training data may include labeled training data and/or unlabeled training data. In some embodiments, labeled training data refers to text that have previously been assigned one or more semantic labels, while unlabeled training data refers to text that have not previously been assigned a semantic label. For example, in some embodiments, labeled training data may comprise reference text data objects that have each previously been assigned one or more target text data objects, while unlabeled training data may comprise reference text data objects that have not been previously assigned a target text data object. In some embodiments, the source domain training data may include unlabeled source domain training data and/or labeled source domain training data. In some embodiments, the target domain training data may include labeled target domain training data and/or unlabeled target domain training data. For example, in some embodiments, the target domain training data may not include labeled target domain training data. In some embodiments, the source domain training data includes at least labeled source domain training data, and the target domain training data includes at least unlabeled target domain data.

Reference text data objects and target text data objects are examples of text data objects, where a text data object may refer to a collection of text data. Examples of reference text data objects may include medical notes and/or clinical text (e.g., discharge diagnosis). Examples of target text data objects may include diagnosis code descriptions, such as hierarchical condition category (HCC) descriptions and International Classification of Diseases (ICD) code descriptions, such as ICD-10 code descriptions. In some embodiments, a machine learning model, such as a cross-domain classification machine learning model may be configured to generate text classification predictions for reference text data objects, wherein generating a text classification prediction may comprise assigning one or more target text data objects (from a list of candidate target text data objects) to a reference text data object based at least in part on a similarity measure.

The process 400 continues at step operation 402 when the training engine 121 pre-trains a machine learning model on embeddings associated with the source domain training data and target domain training data. In some embeddings, pre-training the machine learning model may comprise generating preliminary weights for the machine learning model using source domain training data and target domain training data (e.g., initializing the weights for the machine learning model using source domain training data and target domain training data). In some embodiments, by pre-training a machine learning model on embeddings associated with source domain training data and target domain training data, the machine learning model learns preliminary embeddings (e.g., initial embeddings) of data associated with the source domain data source, as well as preliminary embeddings of data associated with the target domain data source.

In some embodiments, the machine learning model may be pre-trained using masked language modeling technique, wherein a given sequence of text (e.g., a sentence) is predicted based at least in part on text data preceding the given sequence of text and/or text data following the given sequence of text. For example, in some embodiments, the machine learning model may be pre-trained using masked language modeling technique, wherein a given sequence of text (e.g., a sentence) is predicted based at least in part on text data preceding the given sequence, as well as text data following the given sequence of text.

In some embodiments, the machine learning model may comprise a hierarchical transformer machine learning model, such as a Bidirectional Encoder Representation from Transformers (BERT)-based machine learning model comprising a BERT layer that is layered on top with a Long Short-Term Memory (LSTM) layer. It should be understood, however, that a person of ordinary skill in the relevant art will recognize that the machine learning model may comprise other types of machine learning models.

The step/operation 403 continues when the training engine 121 fine-tunes the machine learning model (after it has been pre-trained) using a contrastive loss function and source domain training data. For example, a cross-domain classification machine learning model may describe a machine learning model that has been pre-trained based at least in part on embeddings associated with source domain training data and target domain training data, and has been fine-tuned using source domain training data (e.g., labeled source domain training data) based at least in part on a contrastive loss function as further described herein. The fine-tuned machine learning model that is the cross-domain classification machine learning model may be configured to generate text classification predictions for reference text data objects originating from or otherwise associated with a target domain (e.g., target domain reference text data objects) that is different from the source domain, wherein generating text classification predictions may comprise assigning target text data objects to the noted reference text data objects. In various embodiments, the cross-domain classification machine learning model may be fine-tuned based at least in part on utilizing preliminary weights (e.g., initialized weights) generated during pre-training (e.g., at step/operation 402). For example, fine-tuning the cross-domain classification machine learning model may comprise transferring the preliminary weights from pre-training based at least in part on source domain training data and target domain training data (e.g., unlabeled target domain training data) to fine-tune (e.g., train) the cross-domain classification machine learning model.

In some embodiments, as noted above, a target domain reference text data object may refer to unlabeled text data objects originating from a data source that is different from the data source associated with the source domain training data (e.g., different from the data source from which the source domain training data originated), and with respect to which one or more predictive tasks may be performed to generate text classification predictions. In some embodiments, fine-tuning the cross-domain classification machine learning model on source domain training data to generate a cross-domain classification machine learning model that can generate text classification predictions for reference text data objects comprises training the pre-trained cross-domain classification machine learning model to generate maximal word similarity scores for text data object pairs for a given reference text data object. In some embodiments, the generated maximal word similarity scores, in turn, may be used to generate text classification predictions for the given reference text data object.

In some embodiments, a text data object pair for a reference text data object may comprise the reference text data object and a target text data object of a set of candidate target text data objects. For example, in some embodiments, for a given reference text data object, a set of candidate target text data objects are processed with respect to the reference text data object to determine a predicted classification output for the reference text data object (e.g., processed to assign one or more target text data objects from the set of candidate target text data objects to the given reference text data object) based at least in part on determining one or more most similar target text data objects to the reference text data object having a threshold-satisfying maximal word similarity score. In some embodiments, the set of candidate target text data objects may be processed to determine a set of n most similar target text data objects to a reference text data object in a descending order of similarity based a at least in part on associated maximal word similarity score.

In some embodiments, a maximal word similarity score describes and/or comprises a maximal value of a transition cost value associated with one or more reference words of the reference text data object and one or more target words of the target text data object. A reference word describes a word in a reference text data object, and a target word describes a word in a target text data object. A word, as used herein, may refer to any n-gram that is deemed to be a unit of frequency determination across a text data object. In some embodiments, the words extracted from a particular text data object include: (i) predefined n-grams that appear in the particular text data object, and (ii) unigrams other than stop words which do not appear in the predefined n-grams. For example, in some embodiments, the unigrams “malignant” and “tumor” are deemed to be occurring words of a text data object if they appear outside of the bigram “malignant tumor.”

In some embodiments, the transition cost value is determined based at least in part on: (i) a word-wise flow data object for the reference text data object and the target text data object that describes, for each word pair comprising a reference word and a target word, a word-wise flow value, and (ii) a word-wise similarity value for each word pair. The maximal word similarity score may be a measure of similarity of two text data objects (e.g., a reference text data object and a target text data object) that describes a maximum cost required to transform the words of a first text data object (e.g., target words of a target text data object) into words of a second text data object (e.g., reference words of a reference text data object). For example, the maximal word similarity score may describe a maximum cost required to transform the target words of a target text data object into reference words of a reference text data object using word-wise similarity values between embeddings of the reference words and the embeddings of the target words. In some embodiments, the maximal word similarity score for a reference text data object and a target text data object describes a maximal value of a transition cost value associated with one or more reference words of the reference text data object and one or more target words of the target text data object.

A transition cost value may describe a measure of cost required to transform the words of a first text data object (e.g., target words of a target text data object) into words of a second text data object (e.g., reference words of a reference text data object). For example, the transition cost value may describe a cost required to transform the target words of a target text data object into reference words of a reference text data object using word-wise similarity values between embeddings of the reference words and the embeddings of the target words. In some embodiments, the transition cost value for a reference text data object and a target text data object is determined based at least in part on: (i) a word-wise flow data object for the reference text data object and the target text data object that describes, for each word pair comprising a reference word and a target word, a word-wise flow value, and (ii) a word-wise similarity value for each word pair.

A word-wise flow value may be a value that describes a component of the document-wide word weight value for a word of a first text data object that is transitioned to a second word of a second text data object. For example, a word-wise flow value may describe a component of the document-wide word weight value for a reference word of a reference text data object that is transitioned to a target word of a target text data object. As another example, a word-wise flow value may describe a component of the document-wide word weight value for a target word of a target text data object that is transitioned to a reference word of a reference text data object. In some embodiments, the combination of all of the various word-wise flow values for reference words of a reference text data object and target words of a target text data object are described by a word-wise flow matrix for the reference text data object and the target text data object. In some embodiments, the sum of all word-wise flow values for a particular reference word is equal to a text-wide word weight value for the particular reference word in the reference text data object. In some embodiments, the sum of all word-wise flow values for a particular target word is equal to a text-wide word weight value for the target word in the target text data object.

A text-wide word weight value may describe a frequency of a corresponding word in a particular text data object relative to the frequencies of other words in the particular text data object. For example, the text-wide weight value may describe a term frequency (e.g., term frequency value) of a corresponding word in a particular text data object relative to the term frequencies of other words in the particular text data object. As another example, the text-wide weight value may describe a term-frequency-inverse-domain-frequency measure of a corresponding word in a particular text data object relative to the term-frequency-inverse-domain-frequency measures of other words in the particular text data object. In some embodiments, maximizing a transition cost value is performed in accordance with a maximization constraint requiring that a sum of each word-wise flow value for a particular reference word of the one or more reference words in a reference text data object is equal to a text-wide word weight value for the particular reference word in the reference text data object. In some embodiments, maximizing a transition cost value is performed in accordance with a maximization constraint requiring that a sum of each word-wise flow value for a particular target word of the one or more target words in a target text data object is equal to a text-wide word weight value for the particular target word in the target text data object. In some embodiments, maximizing a transition cost value is performed in accordance with a maximization constraint requiring that a sum of each word-wise flow value for a particular target word of the one or more target words in a target text data object is equal to a text-wide word weight value for the particular target word in the set of candidate target text data objects.

A word-wise similarity value may be a value that describes a computed measure of similarity between two corresponding words. In some embodiments, the word-wise similarity value for a pair of words may be determined based at least in part on a measure of similarity (e.g., a cosine similarity measure) of the embeddings (e.g., Word2Vec representations) of the noted words.

In some embodiments, the maximal word similarity score is a WMS measure. In some of the noted embodiments, the WMS measure for a reference text data object d and a target text data object g in a set of candidate target text data objects C={g₁, . . . , gₙ} may be determined by performing the operations of the below equation:

$${S}_{dg}^{*} = sim ( d , g ) = max {\sum }_{i = 1}^{m} {\sum }_{j = 1}^{n} {t}_{i j} s ( i , j ) \qquad Equation 1$$

$$\begin{matrix}subject to : & ( 1 ) {\sum }_{j = 1}^{m} {t}_{ij} = {f}_{i}^{d} , i = 1 , … , m \\ & ( 2 ) {\sum }_{i = 1}^{n} {t}_{i j} = {f}_{i}^{g} , j = 1 , … , n\end{matrix}$$

$${t}_{i j} \geq 0 , i = 1 , 2 , … , m ; j = 1 , 2 , … , n$$

In Equation 1: (i) S_{dg}* and sim(d, g) may denote the WMS measure for d and g, (ii) i iterates overt the m words of d, (iii) j iterates over the n words of g, (iv) tᵢⱼ may represent the word-wise flow value for the ith word of d and jth word of g (which may be a non-negative value), (v) s(i, j) may represent the word-wise similarity value for the ith word of d and jth word of g computed through some natural measure like cosine similarity, (vi) fᵢ^{d} may represent the text-wide word weight value for the ith word of din relation to d, (vii) fⱼ^{g} may represent the text-wide word weight value for the jth word of g in relation to g, (viii) max Σᵢ₌₁^{m}Σⱼ₌₁ⁿtᵢⱼs(i, j) may represent the transition cost value, (ix) Σⱼ₌₁^{m}tᵢⱼ=fᵢ^{d}, i=1, . . . , m may represent the maximization constraint requiring that a sum of each word-wise flow value for a particular reference word of the one or more reference words is equal to a document-wide word weight value for the particular reference word in the reference text data object, and (x) Σᵢ₌₁ⁿtᵢⱼ=fᵢ^{g}, j=1, . . . , n may represent the maximization constraint requiring that a sum of each word-wise flow value for a particular target word of the one or more target words is equal to a document-wide word weight value for the particular target word in the target text data object.

In some embodiments, in Equation 1, fᵢ^{d} and fᵢ^{g} may be determined by performing the operations of the below equation for a word w of a text data objects:

$${f}_{w}^{s} = \frac{tf ( w , s )}{{\sum }_{{w}_{o} ∈ s} tf ( {w}_{o} , s )} \qquad Equation 2$$

In Equation 2, f_{w}^{s} may represent the text-wide word weight value for the word w in the text data objects, tf(w, s) may represent the term frequency of the word w in the text data object s, and the summation in the denominator ranges over all words of s.

In some embodiments, the maximal word similarity score may be a Relaxed WMS (RWMS) measure. In some embodiments, the RWMS measure for a reference text data object d and a target text data object gₗ from a set of candidate target text data objects C={g₁, g₂, . . . , gₖ} may be determined by performing the operations of the below equation:

$${S}_{{dg}_{l}}^{*} = s i m ( d , {g}_{l} ) = max {\sum }_{i = 1}^{m} {\sum }_{j = 1}^{n} {t}_{i j} s ( i , j ) subject to : {\sum }_{i = 1}^{m} {t}_{i j} = {f}_{i}^{{g}_{l}} , i = 1 , … , m \\ {t}_{i j} \geq 0 , i = 1 , 2 , … , m ; j = 1 , 2 , … , {n}_{{g}_{l}} \qquad Equation 3$$

In Equation 3: (i) S_{dg}_{ₗ}* and sim(d, gₗ) may denote the RWMS measure for d and gₗ, (ii) i iterates over the m words of d, (iii) j iterates over the n words of gₗ, (iv) tᵢⱼ may represent the word-wise flow value for the ith word of d and jth word of gᵢ (which may be a non-negative value), (v) s(i, j) may represent the word-wise similarity value for the ith word of d and jth word of gᵢ, (vi) fᵢ^{g}^{ₗ} may represent the text-wide word weight value for the ith word of gₗ in relation to gₗ, (vii) Σᵢ₌₁^{m}Σⱼ₌₁ⁿtᵢⱼs(i, j) may represent the transition cost value, (ix) Σⱼ₌₁^{m}tᵢⱼ=fᵢ^{g}^{ₗ}, i=1, . . . , m may represent the maximization constraint requiring that a sum of each word-wise flow value for a particular target word of the one or more target words is equal to a document-wide word weight value for the particular target word in the target text data object. In some embodiments, an optimal solution (e.g., optimal word-wise flow matrix) T*=[t*ᵢⱼ], where tᵢⱼ*=fᵢ^{g}^{ₗ}, if i=argmax_{q}s(p, j); otherwise tᵢⱼ*=0.

In some embodiments, a maximal word similarity score (e.g., RWMS) for a pair of target text data object and reference text data object may be generated based at least in part on word-wise similarity values for word pairs associated with the pair of target text data object and reference text data object that are deemed threshold-satisfying word pairs. For example, in some embodiments, a word-wise similarity value for a given target word (e.g., from a target text data object) with respect to a given reference text data object may comprise word-wise similarity values for threshold-satisfying word pairs.

Threshold-satisfying word pairs may describe word pairs (e.g., a word pair including a reference word and a target word) that are deemed to have a threshold-satisfying similarity. For example, in some embodiments, a threshold-satisfying word pair may describe, for a target word from a target text data object and with respect to a reference text data object, a word pair including the target word and a reference word from the reference text data object that is deemed to have a threshold-satisfying similarity with respect to the target word. In some embodiments, the threshold-satisfying word pairs for a given target word may include r target word pairs, where the r target word pairs may comprise the r word pairs having the top word-wise similarity values relative to one or more word-wise similarity values, where each of the one or more similarity values correspond a word pair comprising the target word and a particular reference word from the reference text data object. For example, given a target word wᵢ^{g} and a reference text data object d={wⱼ¹, wⱼ², wⱼ³, wⱼ⁴}, if s(wᵢ^{g}, wⱼ¹)=0.45 (the word-wise similarity value for wᵢ^{g} and wⱼ¹ equals 0.45), s(wᵢ^{g}, wⱼ²)=0.55 (the word-wise similarity value for wᵢ^{g} and wⱼ² equals 0.55), s(wᵢ^{g}, wᵢ³)=0.70 (the word-wise similarity value for wᵢ^{g} and wⱼ³ equals 0.70), s(wᵢ^{g}, wⱼ⁴)=0.50 (the word-wise similarity value for wᵢ^{g} and wⱼ³ equals 0.50), and if r=1, then the threshold-satisfying word pair for wᵢ^{g} with respect to the reference text d includes word pair (wᵢ^{g}, wⱼ³). As another example, given a target word wᵢ^{g} and a reference text data object d={wⱼ¹, wⱼ², wⱼ³, wⱼ⁴}, if (a) s(wᵢ^{g}, wⱼ¹)=0.55 (the word-wise similarity value for wᵢ^{g} and wⱼ¹ equals 0.55), s(wᵢ^{g}, wⱼ²)=1.0 (the word-wise similarity value for wᵢ^{g} and wⱼ² equals 1.0), s(wᵢ^{g}, wⱼ³)=0.78 (the word-wise similarity value for wᵢ^{g} and wⱼ³ equals 0.78), s(wᵢ^{g}, wⱼ⁴)=0.80 (the word-wise similarity value for wᵢ^{g} and wⱼ³ equals 0.80), and if r=1, then the threshold-satisfying word pair for wᵢ^{g} with respect to the reference text d includes word pair (wᵢ^{g}, wⱼ²).

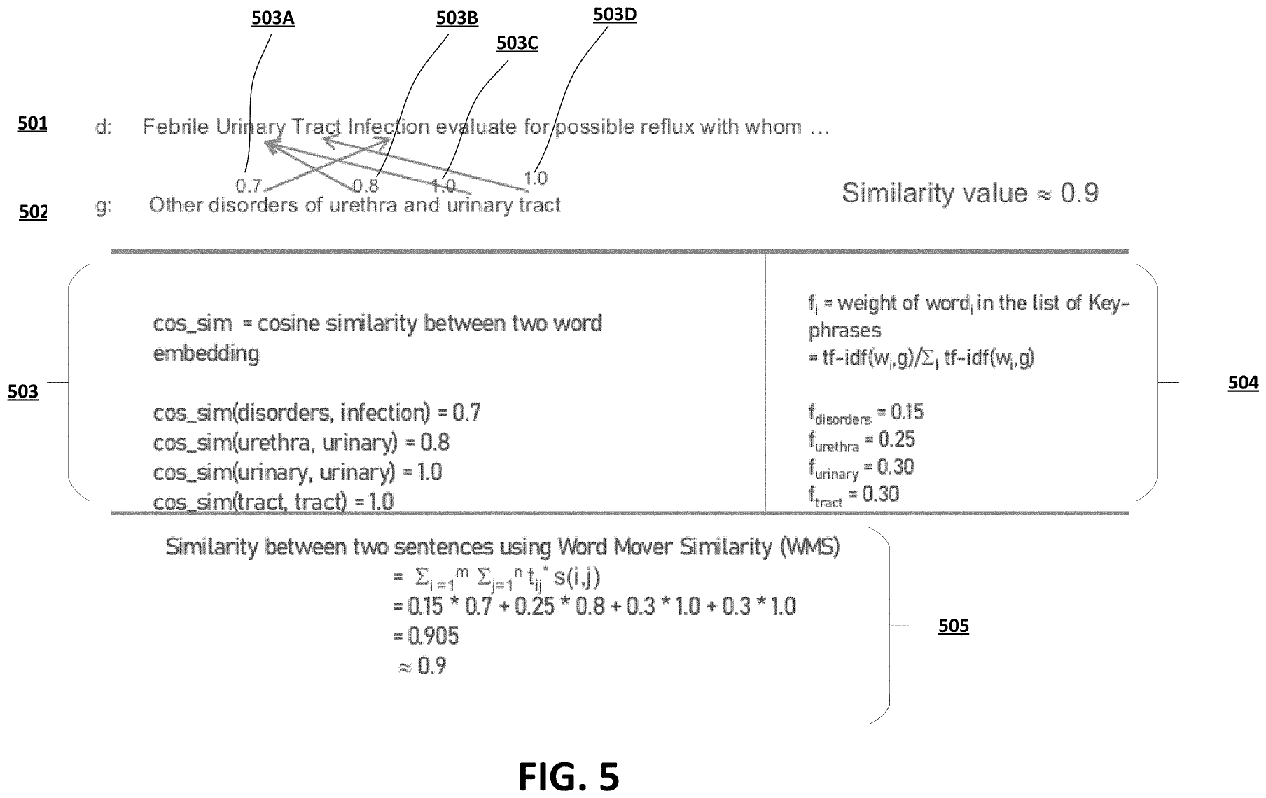

An operational example of generating a RWMS measure for a reference text data object 501 and a target text data object 502 is depicted in FIG. 5. As depicted in FIG. 5, the RWMS measure is generated based at least in part on word-wise similarity values 503 and the text-wide word weight values 504, which are in turn used to generate the RWMS measure based at least in part on the computations 505. As illustrated by the arrows 503A-D, each arrow depicting a word pair, flowing from a target word of the plurality of target words of the target text data object to a corresponding reference word from the plurality of reference words of the reference text data object, a corresponding word-wise similarity value 503 is generated (e.g., computed) for a given word pair comprising a target word wᵢ^{g} and a reference word wⱼ^{d}, where a word-wise similarity value for a given word pair may comprise a cosine similarity measure that is determined based at least in part on the embedding for the target word and the embedding for the corresponding reference word. In some embodiments, as noted above, each word-wise similarity value may comprise a threshold satisfying word pair.

As further depicted in FIG. 5, for each word pair (or each threshold-satisfying word pair) a text-wide word weight values 504 is generated for the word pair based at least in part on the TF-IDF measure of the corresponding target word in word pair relative to the TF-IDF measures of the one or more words in the target text data object, wherein the RWMS measure may be generated based at least in part on the word-wise similarity values 503 and the corresponding text-wide word weight values 504. In some embodiments, WMS measures, RWMS measures, and various techniques discussed herein are described in further detail in commonly owned U.S. application Ser. No. 17/355,731, which is herein incorporated by reference in its entirety.

Returning to FIG. 4, at step/operation 403, fine-tuning the pre-trained cross-domain classification machine learning model using the labeled source domain training data may comprise training the pre-trained cross-domain classification machine learning model based at least in part on a contrastive loss function associated with the source domain training data and the target domain training data. As described above, in some embodiments, labeled source domain training data may refer to text data that have previously been assigned a semantic label, and that originate from a data source that is different from the data source associated with the target domain data. For example, in some embodiments, labeled source domain training data comprises a plurality of training reference text data objects and corresponding assigned target text data object for each training reference text data object of the plurality of training reference text data objects, wherein an assigned target text data object comprises a ground-truth label (e.g., positive label) for the corresponding training reference text data object. In some embodiments, the contrastive loss function is a maximal word similarity-based contrastive loss function.

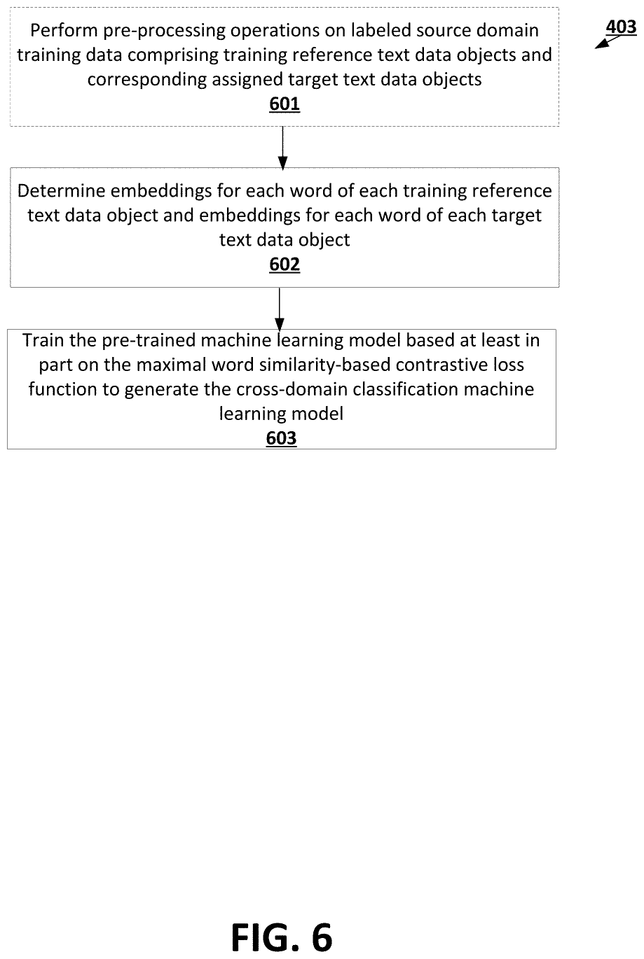

In some embodiments, the step/operation 403 may be performed in accordance with the process that is depicted in FIG. 6, which is an example process for fine-tuning a pre-trained cross-domain classification machine learning model using labeled source domain training data based at least in part on a maximal word similarity-based contrastive loss function associated with the source domain training data and the target domain training data.

The process that is depicted in FIG. 6 begins at step/operation 601 when the training engine 121 performs (e.g., optionally) pre-processing operations on the labeled source domain training data comprising training reference text data objects and corresponding assigned target text data objects. In some embodiments, the preprocessing operations may include removing stop words from the training reference text data objects and/or removing stop words from each candidate target text data object from a set of candidate target text data objects, wherein each target text data object in the set of candidate target text data objects comprise a classification label that may be assigned to a corresponding training reference text data object.

At step/operation 602, the training engine 121 determines: (i) for each training reference text data object, an embedding for each word of one or more words of the training reference text data object, and (ii) for each target text data object, an embedding for each word of one or more words of the target text data object. An embedding may be a data object that describes a feature-describing numeric representation of a word in a text data object (e.g., training reference text data objects, target text data objects, reference text data objects, and/or the like). For example, a labeled embedding for a corresponding labeled word may include a Word2Vec representation of the corresponding word, and/or the like. In some embodiments, the embeddings are determined based at least in part on the embeddings (e.g., preliminary/initial embeddings) learned during pre-training of the cross-domain classification machine learning model.

At step/operation 603, the training engine 121 fine-tunes the pre-trained cross-domain machine learning model. In some embodiments, fine-tuning the pre-trained cross-domain classification machine learning model may comprise updating the weight parameters associated with the embeddings of the training reference text data objects and embeddings of the target text data objects.

In some embodiments, the training engine 121 fine-tunes (e.g., trains) the pre-trained cross-domain classification machine learning model based at least in part on a maximal word similarity-based contrastive loss function associated with the source domain training data and the target domain training data by: (i) generating similarity measures for each training text data object pair and (ii) maximizing the similarity measures for positive training text data object pairs, while minimizing the similarity measures for negative training text data object pairs. For example, in some embodiments, the maximal word similarity-based contrastive loss function may be configured to: (i) maximize similarity measures for positive training text data object pairs and (ii) minimize similarity measures for negative training text data object pairs. In some embodiments, a positive training text data object pair comprises a training reference text data object and corresponding assigned target text data object for the training reference text data object, while a negative text data object comprises a training reference text data object and a target text data object that is not assigned to the training reference text data object. As described above, an assigned target text data object may describe a ground-truth label (e.g., positive label) for the corresponding training reference text data object. While various embodiments of the present invention may discuss singular text classifications for reference text data objects, a person of ordinary skill in the relevant art will recognize that a reference text data object may be signed two or more text classifications (e.g., two or more target text data objects).

In some embodiments, the similarity measure for a training text data object pair may be determined based at least in part on the embeddings determined in step/operation 602 (e.g., the embeddings for each word of the one or more words of the training reference text data object and the embedding for each word of the one or more words of the corresponding target text data object in the training text data object pair). The similarity measure between a pair of words may describe a measure of similarity (e.g., word-wise similarity value) of the embeddings (e.g., Word2Vec representations, and/or the like) of the pair of words. In some embodiments, each similarity measure (e.g., word-wise similarity value) for a word pair of the plurality of word pairs may be determined based at least in part on a cosine similarity of the corresponding embedding of the reference word and the corresponding embedding of the target word.

In some embodiments, the maximal word similarity-based contrastive loss function may be determined by performing the operations of the below equation:

$${ℒ}_{pred} = {\sum }_{{g}_{0} ∈ Γ} log \frac{exp ( Sim ( {g}_{0} , {g}_{k} ) )}{{\sum }_{{g}_{j} ∉ 𝒜 {g}_{0}} exp ( S i m ( {g}_{0} , {g}_{j} ) )} \qquad Equation 4$$

In Equation 4: (i) Sim(g₀, gₖ) may denote the similarity measure (e.g., WMS measure or RWMS measure) for g₀ and gₖ, (ii) (i) Sim(g₀, gₗ) may denote the similarity measure (e.g., WMS measure or RWMS measure) for g₀ and gₗ, (iii) r may represent the number of reference text data objects in the set of candidate target text data objects, (iv) A_{g}_{₀} may represent a subset in the set of candidate target text target text data objects assigned to the particular reference text data object g₀ (e.g., ground-truth labels/positive labels), (v) gₖ may represent an assigned target text data object (e.g., positive label) with respect to the particular training reference text data object g₀, and (vi) gₗ may represent an unassigned target text data object (e.g., negative label) with respect to the particular training reference text data object g₀.

In some embodiments, the gradient

$${Δ}_{w} L = \frac{\partial }{\partial w} L$$

of the maximal word similarity-based contrastive loss function may be determined by performing the operations of the below equations:

$$\frac{\partial }{\partial w} L = \frac{\partial }{\partial w} \text{?} \qquad Equation 5$$

$${Δ}_{w} S ( d , {g}_{k} ) = \text{?} \qquad Equation 6$$

$$\text{?} \text{indicates text missing or illegible when filed}$$

In Equations 5 and Equation 6 above: (i) S(d, gₖ) may be equal to S(x^{d}(w), y^{k}(w)), (ii) x^{d} may represent a vector representation (e.g., embedding) of words of d, (ii) y^{k} may represent a vector representation (e.g., embedding) of words of gₖ, (iii) x^{d} and y^{k} may represent functions of estimation parameters w of the machine learning model, and (iv) S(d, gₖ) and S(d, gₗ) may comprise dot products.

### Generating Text Classification Predictions Using the Cross-Domain Classification Machine Learning Model

According to various embodiments described herein, the inference engine 127 of the predictive data analysis computing entity 106 may generate, using the cross-domain classification machine learning model, text classification predictions for input reference text data objects. In some embodiments, an input reference text data object may describe unlabeled text data originating from a data source that is different from the data source for the labeled training data used to train the cross-domain classification machine learning model (e.g., at step/operation 403), wherein the data source for the labeled training data may correspond to a source domain and the data source for the input reference text data object may correspond to a target domain. Input reference text data objects, for example, may include unlabeled target domain reference text data object (e.g., text data originating from (e.g., associated with) a target domain data source, and that has not been assigned a target text data object). An example of an input reference text data object may include unlabeled clinical text (e.g., unlabeled discharge diagnosis, unlabeled provider notes, and/or the like). In some embodiments, the inference engine 127 of the predictive data analysis computing entity 106, may be configured to: (i) identify one or more input reference text data objects; (ii) generate, using the cross-domain classification machine learning model, a corresponding set of maximal word similarity scores for each input reference text data object with respect to a set of candidate target text data objects; generate a classification output based at least in part on the corresponding set of maximal word similarity scores; and initiate performance of one or more prediction-based actions based at least in part on the corresponding set of maximal word similarity scores. In various embodiments, the set of candidate target text data objects may comprise target text data objects associated with both the source domain data source and the target domain data source, and with respect to which the cross-domain classification machine learning model is trained (e.g., candidate target text data objects utilized in training the pre-trained cross-domain classification machine learning model at step/operation 402). For each input reference text data object, each maximal word similarity score in the set of maximal word similarity scores may comprise a maximal value of a transition cost value associated with one or more reference words of the input reference text data object and one or more target words of a target text data object in the set of candidate target text data objects, wherein the transition cost value is determined based at least in part on: (a) a word-wise flow data object for the input reference text data object and the target text data object, wherein the word-wise flow data object comprises a word-wise flow value for each word pair comprising a reference word and a target word, and (b) a word-wise similarity value for each word pair.

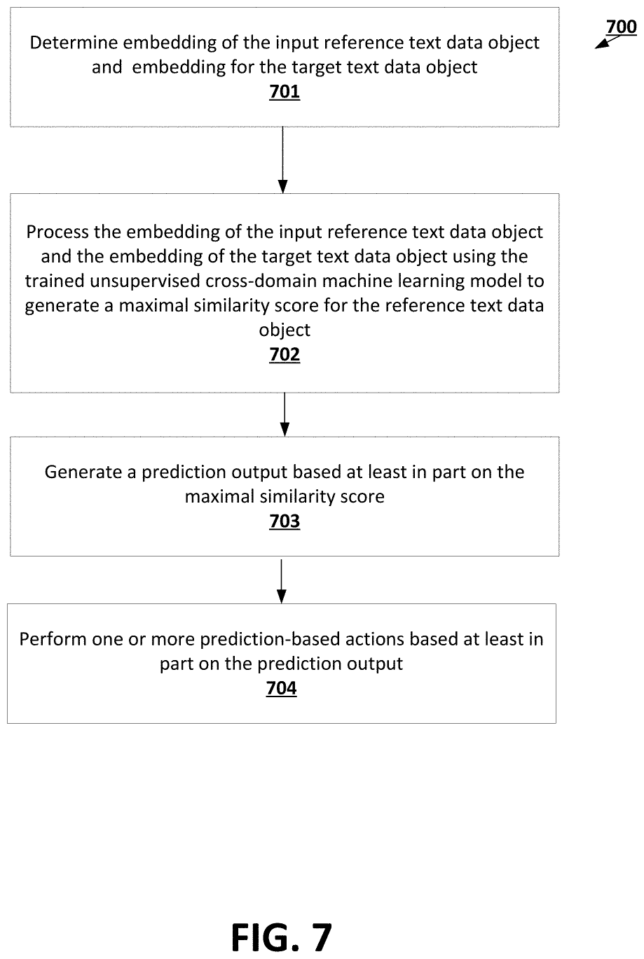

FIG. 7 is a flowchart diagram of an example process 700 for generating text classification predictions for an input reference text data object using a cross-domain classification machine learning model generated in accordance with the process 400 of FIG. 4. Via the various steps/operations of the process 700, the inference engine 127 of the predictive data analysis computing entity 106 can reliably and efficiently generate text classifications for input reference text data objects.

The process 700 begins at step/operation 701 when the inference engine 127 determines (i) an embedding of the input reference text data object (e.g., embedded representation of the input reference text data object), and (ii) an embedding of each target text data object of a set of candidate target text data objects (e.g., embedded representation of a given target text data object). In an example implementation, an input reference text data object may comprise unlabeled clinical text (e.g., unlabeled discharge diagnosis, unlabeled provider notes, and/or the like), and each target text data object in the set of candidate text data objects may comprise a diagnosis code description (e.g., ICD code descriptions) and/or corresponding diagnosis code (e.g., ICD code).

The embedding of the reference text data object may comprise a data object that describes one or more features of the text data associated with the input reference text data object. In some embodiments, the embedding of the input reference text data object includes a per-word representation (e.g., word-level embedding) for each word of one or more words in the reference text data object). For example, the embedding may include a fixed-length distributed word representation for each word of one or more words in the input reference text data object. The embedding of a target text data object may comprise data object that describes one or more features of the text data associated with the target text data object. In some embodiments, the embedding of the target text data object includes a per-word representation for each word of one or more words in the target text data object (e.g., word-level embedding). For example, the embedding may include a fixed-length distributed word representation for each word of one or more words in the target text data object. In some embodiments, the embeddings for the input reference text data object and the embeddings for each target text data object may be generated based at least in part on the embeddings (e.g., preliminary embeddings) learned during pre-training of the cross-domain classification machine learning model.

In some embodiments, the cross-domain classification machine learning model comprise a word-level encoding layer configured for generating a word embedding of each reference word of a reference text data object, and (ii) a document-level encoding layer configured for generating a document embedding of the reference text data object based at least in part on the word embedding for each reference word. For example, in some embodiments, the cross-domain classification machine learning model comprises a hierarchical transformer machine learning model, such as a Bidirectional Encoder Representation from Transformers (BERT)-based machine learning model comprising a BERT layer layered on top with a Long Short-Term Memory (LSTM) layer. It should be understood, however, that a person of ordinary skill in the relevant art will recognize that the cross-domain machine learning model may comprise other types of machine learning models.

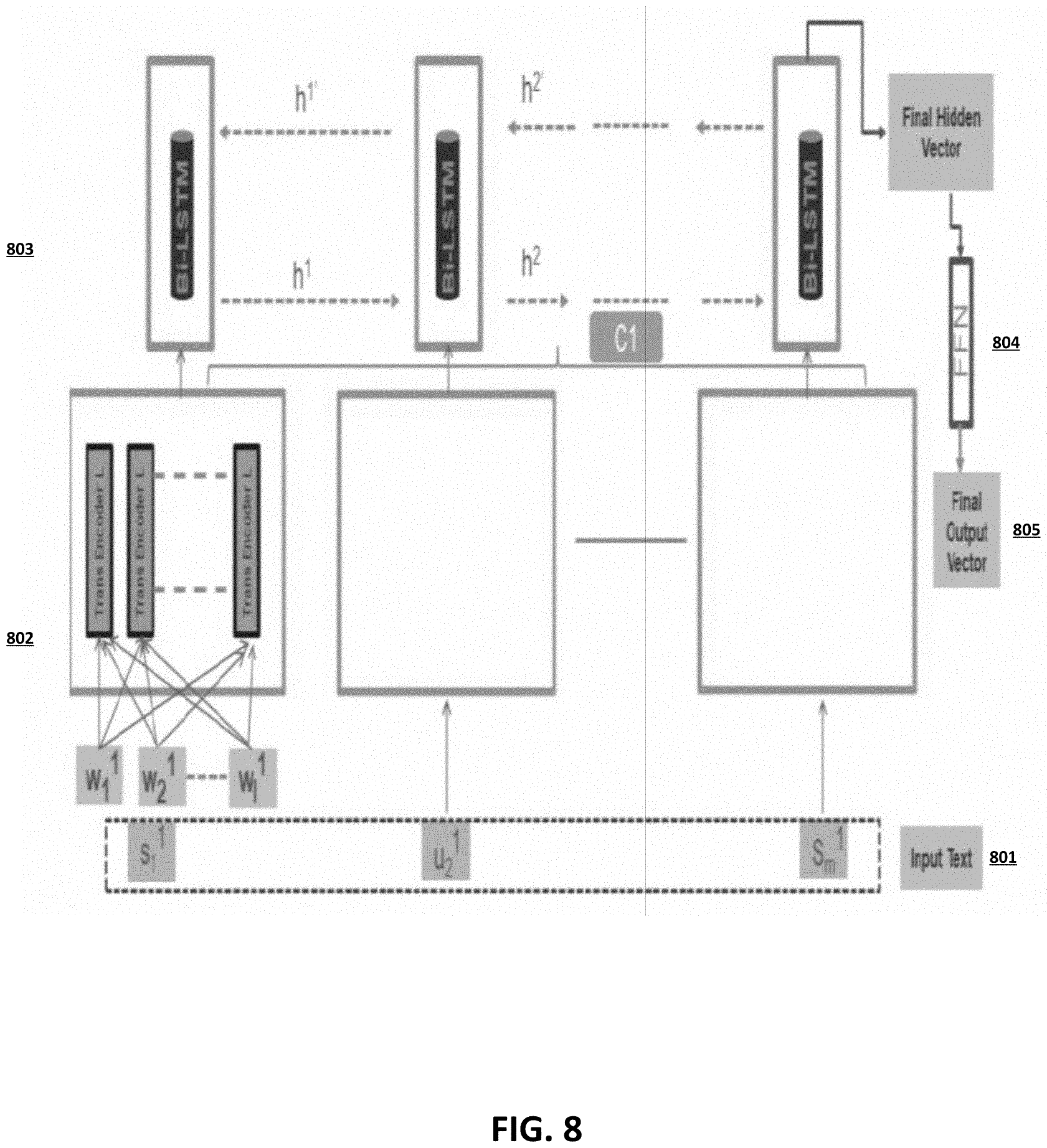

An operational example of determining embeddings for text data objects 801 (e.g., reference text data objects and target text data objects) is depicted in FIG. 8. As depicted in FIG. 8, the cross-domain classification machine learning model may be configured to receive text data objects (e.g., vector representations of input reference text data objects, vector representations of target text data objects). As depicted in FIG. 8, in some embodiments, the vector representation of the text data object 801 (e.g., vector representation of the reference text data object) may be segmented and processed at a first layer (e.g., word-level encoding layer) 802, based at least in part on the size (e.g., number of word tokens) of the text data object and an input size limiter of the BERT layer of the cross-domain classification machine learning model of the depicted example. For example, the cross-domain classification machine learning model may be configured to segment vector representations of text data objects having a size (e.g., number of word tokens) that exceed the input size limiter of the BERT layer. As further depicted in FIG. 8, the output of the first layer may be passed to a second layer 803 (e.g., a Bi-directional LSTM) to generate document-level embeddings. In some embodiments, a target text data object may not be processed by the LSTM layer based at least in part on the size (number of word tokens) of the target text data being less than the input size limiter of the BERT layer. Furthermore, as depicted in FIG. 8, the output of the LSTM layer and/or the BERT layer may be passed to the Feed Forward Neural Network (FNN) 804 of the cross-domain classification machine learning model to generate a final output vector 805 that comprise the embeddings for the input reference text data object and embeddings for the target text data object.

Returning to FIG. 7 at step/operation 702, the inference engine 127 predictive data analysis computing entity 106 processes the embeddings of the input reference text data object and the embeddings of the target text data object using the trained cross-domain classification machine learning model generated in accordance with the process 400 of FIG. 4 to generate a maximal word similarity score for the reference text data object. In some embodiments, the maximal word similarity score comprises a maximal value of a transition cost value associated with one or more reference words of the input reference text data object and one or more target words of a target text data object, wherein the transition cost value is determined based at least in part on: (a) a word-wise flow data object for the input reference text data object and the target text data object, wherein the word-wise flow data object comprises a word-wise flow value for each word pair comprising a reference word and a target word, and (b) a word-wise similarity value for each word pair.

At step/operation 703, the inference engine 127 generates a classification output based at least in part on the maximal word similarity score threshold. In some embodiments, to generate a classification output the inference engine 127 determines if the maximal word similarity score satisfies (e.g., exceeds) a maximal word similarity score threshold. In some embodiments, the inference engine 127, in response to determining that the maximal word similarity score satisfies the maximal word similarity score threshold, assigns the target text data object to the reference text data object. For example, in some embodiments, generating a classification output comprises assigning the target text data object to the reference text data object in response to association with a threshold-satisfying maximal word similarity score. A threshold-satisfying maximal word similarity score may refer to a maximal word similarity score that satisfies (e.g., exceeds) the maximal word similarity score threshold.

In some embodiments, the inference engine 127 generates a ranked similarity list for each reference text data object based at least in part on the corresponding set of maximal word similarity scores. In some embodiments, the ranked similarity list may comprise the most similar target text data objects to the reference text data object in descending order of maximal word similarity scores. In some embodiments, the ranked similarity list may comprise the most similar target text data objects to the reference text data objects having threshold-satisfying maximal word similarity score and may be arranged/presented in descending order of maximal word similarity scores.

At step/operation 704, the predictive data analysis computing entity 106 performs one or more prediction-based actions operations based at least in part on the classification output. In some embodiments, performing the one or more prediction-based actions comprises generating user interface data for a classification output user interface that depicts, for each reference text data object of a list of reference text data objects, a ranked list of identifiers for target text data objects that relate to the reference text data object in a descending order of predicted maximal word similarity score.

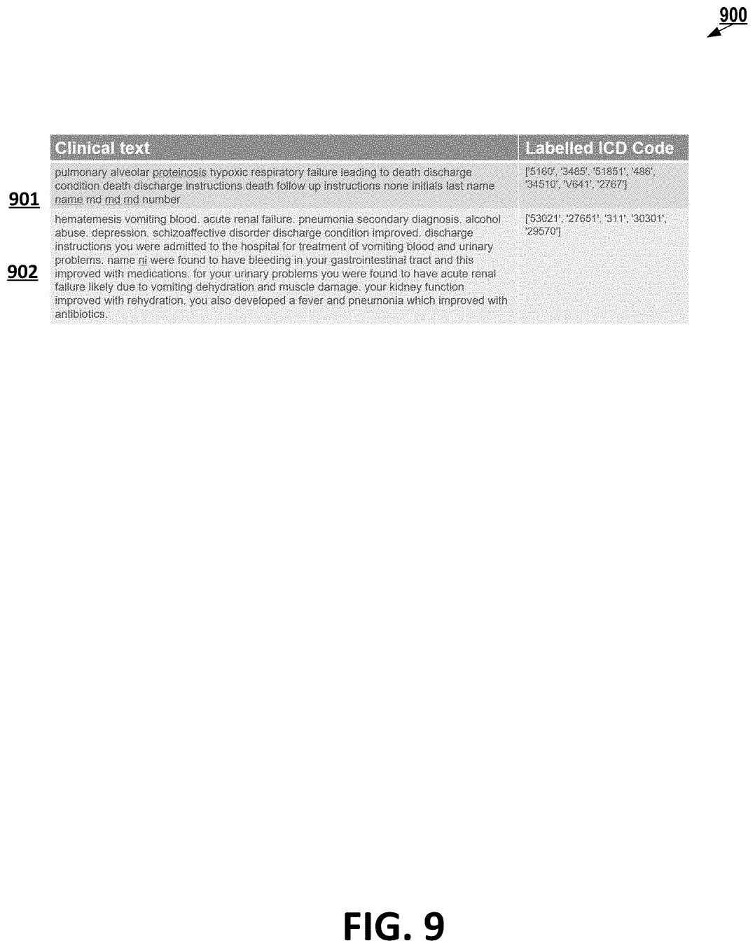

For example, as depicted in FIG. 9, the classification output user interface 900 depicts that: the most similar target text data object to the reference text data object 901 is associated with the medical diagnosis code 5160, the second most similar target text data object to the reference text data object 901 is associated with the medical diagnosis code 3485, the third most similar target text data object to the reference text data object 901 is associated with the medical diagnosis code 51851, the fourth most similar target text data object to the reference text data object 901 is associated with the medical diagnosis code 486, the fifth most similar target text data object to the reference text data object 901 is associated with the medical diagnosis code 34510, the sixth most similar target text data object to the reference text data object 901 is associated with the medical diagnosis code V641, and the seventh most similar target text data object to the reference text data object 901 is associated with the medical code 2767.

As another example, as further depicted in FIG. 9, the classification output user interface 900 depicts that: the most similar target text data object to the reference text data object 902 is associated with the medical diagnosis code 53021, the second most similar target text data object to the reference text data object 902 is associated with the medical diagnosis code 27651, the third most similar target text data object to the reference text data object 902 is associated with the medical diagnosis code 311, the fourth most similar target text data object to the reference text data object 902 is associated with the medical diagnosis code 30301, and the fifth most similar target text data object to the reference text data object 902 is associated with the medical diagnosis code 29570.

### V. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for generating a classification prediction, the computer-implemented method comprising:
for each of one or more input reference text data objects with respect to a set of candidate target text data objects, generating, using a computing entity and a cross-domain classification machine learning model, a set of maximal word similarity scores, wherein:
(i) the cross-domain classification machine learning model has been pre-trained based at least in part on embeddings associated with source domain training data and target domain training data,
(ii) the cross-domain classification machine learning model has been fine-tuned using labeled source domain training data based at least in part on a maximal word similarity-based contrastive loss function associated with the source domain training data and the target domain training data, and
(iii) each maximal word similarity score in the set of maximal word similarity scores comprises a maximal value of a transition cost value associated with one or more reference words of the input reference text data object and one or more target words of a target text data object in the set of candidate target text data objects, wherein the transition cost value is determined based at least in part on: (a) a word-wise flow data object for the input reference text data object and the target text data object, wherein the word-wise flow data object comprises a word-wise flow value for each word pair comprising a reference word and a target word, and (b) a word-wise similarity value for each word pair;
generating, using the computing entity, a classification output based at least in part on the set of maximal word similarity scores; and
initiating, using the computing entity, the performance of one or more prediction-based actions based at least in part on the classification output.

2. The computer-implemented method of claim 1, wherein each input reference text data object comprises text data originating from a target domain data source.

3. The computer-implemented method of claim 1 further comprising generating, using the computing entity, a ranked similarity list for each input reference text data object based at least in part on the set of maximal word similarity scores.

4. The computer-implemented method of claim 1, wherein the cross-domain classification machine learning model is at least one of (i) a Bidirectional Encoder Representation from Transformers (BERT) layer or (ii) a Long Short-Term Memory (LSTM) layer.

5. The computer-implemented method of claim 1, wherein the maximal word similarity-based contrastive loss function is configured to: (i) maximize the maximal word similarity score for positive training text data object pairs comprising a training reference text data object and an assigned target text data object and (ii) minimize the maximal word similarity score for negative training text data object pairs comprising the training reference text data object and the unassigned target text data object.

6. The computer-implemented method of claim 1, wherein the source domain training data comprises labeled training data and unlabeled training data.

7. The computer-implemented method of claim 1, wherein generating the classification output comprises assigning the target text data object to each input reference text data object in response to association with a threshold-satisfying maximal word similarity score.

8. The computer-implemented method of claim 1, wherein the transition cost value is maximized in accordance with a maximization constraint requiring that a sum of each word-wise flow value for a particular target word be equal to a document-wide word weight value for the particular target word in the target text data object.

9. The computer-implemented method of claim 8, wherein the document-wide word weight value is determined based at least in part on: (i) a term frequency value of the particular target word in the target text data object, or (ii) a sum of each term frequency value for the one or more target words in the set of candidate target text data objects.

10. An apparatus for generating a classification prediction, the apparatus comprising at least one processor and at least one memory including program code, the at least one memory and the program code configured to, with the processor, cause the apparatus to at least:
for each of one or more input reference text data objects with respect to a set of candidate target text data objects, generate, using a cross-domain classification machine learning model, a set of maximal word similarity scores, wherein:
(i) the cross-domain classification machine learning model has been pre-trained based at least in part on embeddings associated with source domain training data and target domain training data,
(ii) the cross-domain classification machine learning model has been fine-tuned using labeled source domain training data based at least in part on a maximal word similarity-based contrastive loss function associated with the source domain training data and the target domain training data, and
(iii) each maximal word similarity score in the set of maximal word similarity scores comprises a maximal value of a transition cost value associated with one or more reference words of the input reference text data object and one or more target words of a target text data object in the set of candidate target text data objects, wherein the transition cost value is determined based at least in part on: (a) a word-wise flow data object for the input reference text data object and the target text data object, wherein the word-wise flow data object comprises a word-wise flow value for each word pair comprising a reference word and a target word, and (b) a word-wise similarity value for each word pair;
generate a classification output based at least in part on the set of maximal word similarity scores; and
initiate the performance of one or more prediction-based actions based at least in part on the set of maximal word similarity scores.

11. The apparatus of claim 10, wherein the input reference text data object comprises text data originating from a target domain data source.

12. The apparatus of claim 10, wherein the at least one memory and the program code configured to, with the processor, further cause the apparatus to at least generate a ranked similarity list for each input reference text data object based at least in part on the set of maximal word similarity scores.

13. The apparatus of claim 10, wherein the cross-domain classification machine learning model is at least one of (i) a Bidirectional Encoder Representation from Transformers (BERT) layer or (ii) a Long Short-Term Memory (LSTM) layer.

14. The apparatus of claim 10, wherein the maximal word similarity-based contrastive loss function is configured to: (i) maximize the maximal word similarity score for positive training text data object pairs comprising a training reference text data object and an assigned target text data object and (ii) minimize the maximal word similarity score for negative training text data object pairs comprising the training reference text data object and the unassigned target text data object.

15. The apparatus of claim 10, wherein the source domain training data comprises labeled training data and unlabeled training data.

16. The apparatus of claim 10, wherein generating the classification output comprises assigning the target text data object to each input reference text data object in response to association with a threshold-satisfying maximal word similarity score.

17. The apparatus of claim 10, wherein the transition cost value is maximized in accordance with a maximization constraint requiring that a sum of each word-wise flow value for a particular target word be equal to a document-wide word weight value for the particular target word in the target text data object.

18. The apparatus of claim 17, wherein the document-wide word weight value is determined based at least in part on: (i) a term frequency value of the particular target word in the target text data object, or (ii) a sum of each term frequency value for the one or more target words in the set of candidate target text data objects.

19. A computer program product for generating a classification prediction, the computer program product comprising at least one non-transitory computer-readable storage medium having computer-readable program code portions stored therein, the computer-readable program code portions configured to:
for each of one or more input reference text data objects with respect to a set of candidate target text data objects, generate, using a cross-domain classification machine learning model, a set of maximal word similarity scores, wherein:
(i) the cross-domain classification machine learning model has been pre-trained based at least in part on embeddings associated with source domain training data and target domain training data,
(ii) the cross-domain classification machine learning model has been fine-tuned using labeled source domain training data based at least in part on a maximal word similarity-based contrastive loss function associated with the source domain training data and the target domain training data, and
(iii) each maximal word similarity score in the set of maximal word similarity scores comprises a maximal value of a transition cost value associated with one or more reference words of the input reference text data object and one or more target words of a target text data object in the set of candidate target text data objects, wherein the transition cost value is determined based at least in part on: (a) a word-wise flow data object for the input reference text data object and the target text data object, wherein the word-wise flow data object comprises a word-wise flow value for each word pair comprising a reference word and a target word, and (b) a word-wise similarity value for each word pair;
generate a classification output based at least in part on the set of maximal word similarity scores; and
initiate the performance of one or more prediction-based actions based at least in part on the set of maximal word similarity scores.

20. The computer program product of claim 19, wherein each input reference text data object comprises text data originating from a target domain data source.
